(19) United States
(12) Patent Application Publication
(10) Pub. No.: US 2023/0357067 A1
(43) Pub. Date: Nov. 9, 2023

(54) CATIONIC EMULSION TERPOLYMER TO INCREASE CAKE SOLIDS IN CENTRIFUGES

(71) Applicant: SOLENIS TECHNOLOGIES, L.P., Wilmington, DE (US)

(72) Inventors: Nathalie Bruzzano, Duisburg (DE); Markus Bröcher, Mühlheim an der Ruhr (DE)

(73) Assignee: SOLENIS TECHNOLOGIES, L.P., Wilmington, DE (US)

(21) Appl. No.: 17/661,930

(22) Filed: May 4, 2022

(51) Int. Cl. C02F 11/147; C08F 220/34; C08F 220/56; C02F 11/127; C02F 11/122

(52) U.S. Cl. CPC C02F 11/147; C08F 220/34; C08F 220/56; C02F 11/127; C02F 11/122

(57) ABSTRACT

The present disclosure generally relates to dewatering aqueous sludge that is produced by waste water or sewage treatment facilities such as from municipal and industrial processes. The method includes treating an aqueous sludge with a cationic polyacrylamide terpolymer that includes an acrylamide; a first cationic monomer and a second cationic monomer that is different from the first monomer, and dewatering the treated aqueous sludge.

### TECHNICAL FIELD

The present disclosure generally relates to dewatering aqueous sludge that is produced by waste water or sewage treatment facilities such as from municipal and industrial processes. The method includes treating an aqueous sludge with a cationic polyacrylamide terpolymer that includes an acrylamide; a first cationic monomer and a second cationic monomer that is different from the first monomer, and dewatering the treated aqueous sludge.

### BACKGROUND

The effluent streams coming from the processes mentioned above, generally contain waste solids that cannot be directly recycled and are conveyed by a sewerage system to a waste water treatment plant facility. The effluent stream goes through a series of operations depending on the particular industry and set-up of the waste water treatment facility, to concentrate and dewater the waste solids thereby producing a sludge. Ultimately, the industrial effluent stream is passed through a filter press, such as, a chamber filter press, plate filter press, frame filter press, membrane filter press, screw filter press and belt filter press or through a centrifuge, wherein the waste solids are concentrated into a primary sludge or filter cake and the filtered waste water from the press or centrifuge is further processed until it is fit for discharge or reuse.

A typical sewage treatment plant takes in raw sewage and produces solids and clarified water. Typically the raw sewage is treated in a primary sedimentation stage to form a primary sludge and supernatant, the supernatant is subjected to biological treatment and then a secondary sedimentation stage to form a secondary sludge and clarified liquor, which is often subjected to further treatment before discharge.

It is standard practice to dewater the sludge by mixing a dose of polymeric flocculant into that sludge at a dosing point, and then substantially immediately subjecting the sludge to the dewatering process and thereby forming a cake and a reject liquor. The dewatering process may be centrifugation or may be by processes such as filter pressing or belt pressing.

In many countries, for regulatory reasons, most sludge cake is going to landfill. For landfill, the cake must be drier than 40% and also the amount of sludge going into any landfill must not be greater than 8% (mixture ratio). Therefore, it is desirable (i) to increase the content of separated dry matter (OS), if possible above about 40 wt.-%, i.e. to keep the sludge cake moisture below about 60 wt.-% using current processes.

In conventional or standard processes of dewatering aqueous sludge various ionic, anionic and cationic polymers have been added to aqueous sludge as polymeric flocculants to induce flocculation formation of the solid materials in the sludge. Other methods have included adding quick lime (CaO) to the aqueous sludge in order to increase dry matter contents (OS). However, the addition of quick lime is expensive and laborious. Therefore, there is a demand for simple processes for dewatering sludge which achieves high solids contents. In particular, it is an objective to increase the residual dry matter in the filter cake of dewatered sludge and to decrease the moisture content in the filter cake, respectively.

Therefore, it was an objective to provide copolymer compositions that show improved performance as a dewatering aid for sludge dewatering in waste water and sewage treatment.

The currently produced composition uses a cationic polyacrylamide terpolymer that provides for improved efficacy in dewatering aqueous sludge. Although not wanting to be bound by theory, it is believed the second cationic monomer, exhibits a methyl group attached directly to the polymer backbone. This provides a stiffer polymer having a different conformation than conventional or standard CPAM polymers.

### BRIEF SUMMARY

The current disclosure relates to a method of dewatering aqueous sludge. The method involves treating the aqueous sludge with a cationic polyacrylamide terpolymer that comprises an acrylamide; a first cationic monomer; and a second cationic monomer that is different from the first cationic monomer. The treated aqueous sludge is then dewatered.

Also disclosed is a method of increasing cake dryness in a sludge dewatering processes that includes treating an aqueous sludge with a cationic polyacrylamide terpolymer that includes an acrylamide; a first cationic monomer and a second cationic monomer that is different from the first monomer. The treated aqueous sludge is then dewatered producing a filter cake, which can be disposed of accordingly.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DETAILED DESCRIPTION

The following detailed description is merely exemplary in nature and is not intended to limit the invention or the application and uses of the invention. Unless specifically stated or obvious from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

The aqueous sludge to be dewatered by the process according to the invention is not particularly limited. The aqueous sludge as a starting material comes from, for example, mining sludge, municipal sludge, paper sludge and industrial sludge. It may be digested sludge, activated sludge, coarse sludge, raw sludge, and the like, and mixtures thereof.

In some aspects, the current method relates to a method of dewatering aqueous sludge. The aqueous sludge is treated with a cationic polyacrylamide terpolymer that includes an acrylamide; a first cationic monomer; and a second cationic monomer that is different from the first cationic monomer. The treated aqueous sludge is then dewatered. The resulting filter cake can then be disposed of accordingly.

In some aspects of the current method, the first cationic monomer is an acrylate monomer. For example, the first cationic monomer can be [2-(acryloyloxy)ethyl]trimethyl ammonium chloride (AETAC) (also known as 2-(dimethylamino)ethyl acrylate methylchloride (ADAME-Q, DMA3Q), acryloyloxyethyltrimethyl ammonium chloride), 3-acrylamidopropyl)trimethyl ammonium chloride (APTAC, DiMAPA-Q) and combinations thereof.

In some aspects of the current method, the second cationic monomer is a methacrylate monomer. For example the second cationic monomer can be [2-(methacryloyloxy)ethyl]trimethyl ammonium chloride (MADAME-Q) (also known as 2-dimethylamino)ethyl methacrylate (MADAME-Q) and trimethylammonium ethyl methacrylate chloride (TMAEMC)), [3-(methacryloylamino)propyl] trimethyl ammonium chloride (MAPTAC, DiMAPMA-Q) and combinations thereof. The second cationic monomer should exhibit a methyl group that can attach directly at the polymer backbone.

A typical CPAM polymer is a random coil (freely jointed chain) in tab water (process water). The terpolymer has the methyl group on the backbone the free coiling is more hindered, and the conformation of the coil is wider and a bit stiffer.

In some aspects of the current method, the first cationic monomer and the second cationic monomer are present in a weight ratio of from about 95:5 wt % to about 50:50 wt %.

In other aspects of the current method, the terpolymer has an overall charge density of from about 50 wt % to about 100 wt % or from about 25 mole % to 100 mole %.

In some aspects of the current method, the step of dewatering is further defined as a centrifugation step or process.

In other aspects of the current method, the step of dewatering utilizes at least one of a chamber filter press, plate filter press, frame filter press, membrane filter press, screw filter press and belt filter press.

In some aspects of the current method, the aqueous sludge is derived from municipal, industrial, paper waste water or mining processes.

In other aspects, the current method relates to a method of increasing cake dryness in a sludge dewatering processes that includes treating an aqueous sludge with a cationic polyacrylamide terpolymer that includes an acrylamide; a first cationic monomer and a second cationic monomer that is different from the first monomer. The treated aqueous sludge is then dewatered producing a filter cake.

In yet other aspects of the method, the filter cake solids from the treated aqueous sludge is increased by at least 15% when compared with filter cake solids of aqueous sludge treated with standard polymers under the same conditions.

### Examples

### Preparation of Comparative Composition

An aqueous phase was prepared by adding 276 g acrylamide (50 wt %), 0.6 g Trilon C, 394 g ADAME Quat (80 wt %), 90 g water and 2 ppm N,N′-methylene bis acrylamide to a 2-liter (L) beaker. While stirring, the pH was adjusted to a pH of 3 using sulphuric acid. In a second 2-L beaker, an organic phase was prepared by mixing 20 g Zephrym 7053, 3 g Degacryl 3059 L, 12.7 g Intrasol FA1218/5 and 247 g paraffin oil. See Table 1.

The aqueous phase was then charged to the oil phase under vigorous stirring followed by mixing with a homogenizer to obtain a stable water-in-oil inverse emulsion. The inverse emulsion was added to a 2 L glass reaction vessel equipped with an anchor stirrer, thermometer and a distillation device and the emulsion was evacuated. The temperature of the emulsion was adjusted to 63±1° C. and after 30 minutes of air stripping or distillation to remove any volatile organic compounds (VOCs), the polymerization was initiated by an initial charge of a 1 wt. % V-65 in oil based on total weight of the emulsion. The amount of distillate under negative pressure was 110 milliliters (ml). After the distillation, the vacuum was removed. The residual monomers react adiabatically typically reaching a maximum temperature of about 70° C. The emulsion was stirred for an additional 15 minutes, and vacuum was again applied until the vessel cooled to 40° C. The vacuum was discontinued and two grams (g) of sodium peroxodisulfate (25 wt. %) and eleven grams sodium bisulfite (25 wt. %) were added to the vessel to reduce the monomer content. Finally, an activator was added to the vessel under stirring to the final product to invert the inverse emulsion more easily in water. If the inverse emulsion is given to water the polymer is dissolved in the water after inversion.

### Preparation of New Composition

The new composition was prepared as with the standard composition, except that both ADAME Quat and MADAME Quat monomers were added to the water phase—276 g acrylamide (50 wt %), 276 g ADAME Quat (80 wt %), 126 g MADAME-Q (75 wt %) and 2 ppm N,N′-methylene. The total monomer concentration is again 450 g (see Table 1).

TABLE 1
Formulations

| First Beaker-Standard Composition | First Beaker-New Composition |
|---|---|
| ADAME Quat (acryloyl oxyethyl | ADAME Quat (acryloyl oxyethyl |
| trimethylammonium chloride) | trimethylammonium chloride) |
| Trilon C-chelator | Trilon C-chelator |
| N,N′-methylene bis acrylamide | N,N′-methylene bis acrylamide |
| | MADAME Quat |
| | (methacryloyl oxyethyl |
| | trimethylammonium chloride) |
| Second Beaker-Standard | Second Beaker-New |
| Composition | Composition |
| Zephrym 7053-hydrophobic | Zephrym 7053-hydrophobic |
| emulsifier | emulsifier |
| Degacryl 3059 L-shear stabilizer | Degacryl 3059 L-shear stabilizer |
| Intrasol FA1218/5-hydrophilic | Intrasol FA1218/5-hydrophilic |
| emulsifier | emulsifier |
| (alcohols, C12-18, | (alcohols, C₁₂₋₁₈, |
| ethoxylated >1<2.5 mole) | ethoxylated >1<2.5 mole) |
| Paraffin oil | Paraffin oil |

Samples of aqueous sludge were obtained from three different waste water facilities located in Germany, i.e. Koln; Angertal; and Essity Mannheim. From each facility, two 500 milliliter (ml) samples of sludge were treated with two different dosages of a standard drainage aid that were used as a benchmark in the study. The sludge from each of the facilities was treated with two different dosage levels as indicated in Tables 2-4. The samples were sheared at 1000 rpm with a four-fingered stirrer for 10-20 seconds, to simulate the centrifuges used in the dewatering facilities. The aqueous sludge was dewatered using a 315 micron (μm) metallic sieve. The dewatering time of 300 ml filtrate was measured and the clarity of the filtrate determined using a graduated measuring wedge.

A plexiglass disc was used to cover the filter cake that remained in the sieve and a 10 kilogram (kg) weight was placed on top of the plexiglass disc for 1 minute at which time cake compactness was evaluated by visual inspection to determine if the filter cakes press ability was good, fair, or bad. Second, a part of the pressed filter cake (weighted) was placed in a heating oven at 105° C. overnight. The dried filter cake was weighed back and the total solids (TS) of the cake was noted.

### Dewatering Time and Clarity

TABLE 2
KA Köln-Langel

| | 220 ppm = 9.6 kg/t | | | 260 ppm = 11.3 kg/t | | |
|---|---|---|---|---|---|---|
| | De- | | TS cake | De- | | TS cake |
| | watering | | solid | watering | | solid |
| | time [s] | Clarity | [%] | time [s] | Clarity | [%] |
| New | 8 | 17 | 10.8 | 3 | 23 | 11.2 |
| Composition | | | | | | |
| (ADAME-Q/ | | | | | | |
| MADAME-Q) | | | | | | |
| New | n.a. | n.a. | n.a. | 9 | 14 | 10.3 |
| Composition | | | | | | |
| (ADAME-Q/ | | | | | | |
| DIMAPA-Q) | | | | | | |
| Standard | 20 | 5 | 9.2 | 8 | 9 | 10.1 |
| Composition | | | | | | |

Dewatering (time for 300 ml filtrate): lower is better
Clarity (filtrate in turbidity wedge): higher is better
TS cake solid (105° C., overnight): higher is better

As can be seen from Table 2, the terpolymer composition comprising both the acrylate and methacrylate monomers had improved efficacy over a standard formulation. Table 2 also indicates that there are only selective combinations that will provide the desired results.

TABLE 3
KA Angertal

| | 290 ppm | | | 330 ppm | | |
|---|---|---|---|---|---|---|
| | De- | | TS cake | De- | | TS cake |
| | watering | | solid | watering | | solid |
| | time [s] | Clarity | [%] | time [s] | Clarity | [%] |
| New | 4 | 36 | 11.3 | <3 | 28 | 11.3 |
| Terpolymer | | | | | | |
| Composition | | | | | | |
| Standard | 16 | 9 | 10.3 | 5 | 17 | 10.9 |
| Composition | | | | | | |

Dewatering (time for 300 ml filtrate): lower is better
Clarity (filtrate in turbidity wedge): higher is better
TS cake solid (105° C., overnight): higher is better

Results in Table 3, indicate that the new terpolymer composition provided significantly better results than the standard formulation.

TABLE 4
Essity Mannheim, paper sludge

| | 300 ppm = 9.0 kg/t | | | 340 ppm = 10.1 kg/t | | |
|---|---|---|---|---|---|---|
| | De- | | TS cake | De- | | TS cake |
| | watering | | solid | watering | | solid |
| | time [s] | Clarity | [%] | time [s] | Clarity | [%] |
| New | 4 | 9 | 14.0 | <3 | 10 | 14.5 |
| Terpolymer | | | | | | |
| Composition | | | | | | |
| Standard | 13 | 1 | 13.0 | 5 | 3 | 13.2 |
| Composition | | | | | | |

Dewatering (time for 300 ml filtrate): lower is better
Clarity (filtrate in turbidity wedge): higher is better
TS cake solid (105° C., overnight): higher is better

Results in Table 4, indicate that the new terpolymer composition provided significantly better results than the standard formulation.

Studies have shown that the residual dry matter (OS) in the filter cake can be improved by as much as 15% when compared with the Standard composition.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. A method of dewatering aqueous sludge, said method comprising:
a) treating the aqueous sludge with a cationic polyacrylamide terpolymer comprising: acrylamide; a first cationic monomer; and a second cationic monomer that is different from the first cationic monomer;
b) dewatering the treated aqueous sludge obtained from step a).

2. The method according to claim 1, wherein the first cationic monomer is an acrylate monomer.

3. The method according to claim 2, wherein the first cationic monomer is chosen from [2-(acryloyloxy)ethyl]trimethyl ammonium chloride, (3-acrylamidopropyl)trimethyl ammonium chloride and combinations thereof.

4. The method according to any one of claim 1, wherein the second cationic monomer is a methacrylate monomer.

5. The method according to claim 4, wherein the second cationic monomer is chosen from [2-(methacryloyloxy)ethyl]trimethyl ammonium chloride, [3-(methacryloylamino)propyl] trimethyl ammonium chloride and combinations thereof.

6. The method according to any one of claim 1, wherein the first cationic monomer and the second cationic monomer are present in a weight ratio of from about 95:5 to about 50:50.

7. The method according to any one of claim 1, wherein the terpolymer has an overall charge density of from about 50 wt. % to about 100 wt. % or from about 25 mole % to 100 mole %.

8. The method according to any one of claims 1-7, wherein the step of dewatering is further defined as centrifugation.

9. The method according to any one of claim 1, wherein the step of dewatering utilizes at least one of a chamber filter press, plate filter press, frame filter press, membrane filter press, screw filter press and belt filter press.

10. The method according to any one of claim 1, wherein the aqueous sludge is derived from municipal, industrial, paper waste water or mining processes.

11. A method of increasing cake dryness in a sludge dewatering processes comprising:
a) treating an aqueous sludge with a cationic polyacrylamide terpolymer comprising: acrylamide; a first cationic monomer and a second cationic monomer that is different from the first monomer;
b) dewatering the treated aqueous sludge obtained from step a) producing a filter cake.

12. The method according to claim 11, wherein the first cationic monomer is an acrylate monomer.

13. The method according to claim 12, wherein the first cationic monomer is chosen from [2-(acryloyloxy)ethyl]trimethyl ammonium chloride, (3-acrylamidopropyl)trimethyl ammonium chloride and combinations thereof.

14. The method according to claim 11, wherein the second cationic monomer is a methacrylate monomer.

15. The method according to claim 4, wherein the second cationic monomer is chosen from [2-(methacryloyloxy)ethyl]trimethyl ammonium chloride, [3-(methacryloylamino)propyl] trimethyl ammonium chloride and combinations thereof.

16. The method according to claim 11, wherein the ratio of the first cationic monomer to the second cationic monomer is from about 95:5 to about 50:50.

17. The method according to claim 11, wherein the terpolymer has an overall charge density of from about 50 wt. % to about 100 wt. % or from about 25 mole % to 100 mole %.

18. The method according to claim 11, wherein the step of dewatering is further defined as centrifugation.

19. The method according to claim 11, wherein the step of dewatering utilizes at least one of a chamber filter press, plate filter press, frame filter press, membrane filter press, screw filter press and belt filter press.

20. The method according to claim 11, wherein the aqueous sludge is derived from municipal, industrial, paper waste water or mining processes.

21. The method according to claim 11, wherein the filter cake solids from the treated aqueous sludge is increased by at least 15% when compared with filter cake solids of aqueous sludge treated with conventional polymers under the same conditions.
